(19) United States
(12) Patent Application Publication
(10) Pub. No.: US 2005/0007932 A1
(43) Pub. Date: Jan. 13, 2005

(54) Optical head, optical disk drive, and optical system adjustment method

(75) Inventor: Sou Ishika, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/875,527

(22) Filed: Jun. 25, 2004

(30) Foreign Application Priority Data
Jun. 25, 2003 (JP) 2003-181515

(51) Int. Cl. G11B 7/00

(52) U.S. Cl. 369/112.05; 369/44.23; 369/112.16; 369/44.37

(57) ABSTRACT

An optical head according to an example of this invention has a polarization beam splitter, objective lens, photodetection element, first optical diffraction element, and second optical diffraction element. The first optical diffraction element is arranged on the optical path between the polarization beam splitter and objective lens. The first optical diffraction element passes a first light beam of a first wavelength and a second light beam of a second wavelength longer than the first wavelength through it, diffracts a first reflected light beam obtained from an optical disk in correspondence with the first light beam, and passes a second reflected light beam obtained from the optical disk in correspondence with the second light beam through it. The second optical diffraction element is arranged on the optical path between the polarization beam splitter and photodetection element, passes the first reflected light beam, and diffracts the second reflected light beam.

### CROSS-REFERENCE TO RELATED APPLICATIONS

This application is based upon and claims the benefit of priority from prior Japanese Patent Application No. 2003-181515, filed Jun. 25, 2003, the entire contents of which are incorporated herein by reference.

### BACKGROUND OF THE INVENTION

1. Field of the Invention

The present invention relates to an optical head which irradiates an optical disk with a light beam, and detects light reflected by the optical disk. The present invention also relates to an optical disk drive which mounts such optical head. Furthermore, the present invention relates to an optical system adjustment method in such optical head.

2. Description of the Related Art

An optical disk drive has an optical head which comprises an objective lens, photodetector, and the like. The optical head irradiates the recording surface of an optical disk with a light beam, and detects light reflected by the optical disk. The optical head reads information recorded on the optical disk on the basis of the detected reflected light. Also, the optical head irradiates the recording surface of the optical disk with a light beam to record target information on that optical disk.

Generation of various signals based on light reflected by an optical disk will be explained below. Reflected light from the optical disk is guided to a predetermined photodetection region of the photo-detector via the objective lens and a plurality of optical elements. The photodetector converts the guided reflected light into an electrical signal. A reproduction signal of information recorded on the optical disk is generated based on the electrical signal converted by the photodetector. Also, a tracking control signal is generated based on the electrical signal converted by the photodetector. Furthermore, a focus control signal is generated based on the electrical signal converted by the photodetector. The tracking control signal is used in tracking control that adjusts a light spot projected onto the recording surface of the optical disk to match the track center of the recording surface. The focus control signal is used in focusing control that changes the position of the objective lens to just-focus the light spot on the recording surface.

The objective lens is held by a lens holder, which is supported by one-end portions of a plurality of elastic support springs. The lens holder can physically undergo micromotion control by tracking and focusing coils. With this mechanism, lens shift is realized to attain focusing and tracking.

Furthermore, in recent years, DVDs (Digital Versatile Disks) have prevailed remarkably, and compatible devices for CDs (Compact Disks) which have arrived on the market and DVDs, i.e., optical disk drives that can handle both types of media, are commercially available. As is known, the DVD and CD have considerably different recording densities. Accordingly, light beams to be emitted for the DVD and CD have different wavelengths. As disclosed in Jpn. Pat. Appln. KOKAI Publication No. 2003-16672, a compatible device requires processes for two light beams having different wavelengths.

As a generation method of a focus error signal, a knife edge (or double knife edge) method is known. In the knife edge (or double knife edge) method, one knife edge (two knife edges) is (are) set on the focusing optical path width of light reflected by a disk, and the moving amount of a light point image on a light-receiving element is detected to generate a focus error signal.

When the knife edge (or double knife edge) method is used in focus control, a light-receiving element used to generate a focus error signal, and that used to generate a tracking error signal such as a DPP signal, DPD, signal, or the like must be independently arranged. Furthermore, when the knife edge (or double knife edge) method is used in focus control, a light-receiving element used to detect reflected light from a CD and that used to detect reflected light from a DVD must be independently arranged.

### BRIEF SUMMARY OF THE INVENTION

An optical head according to one aspect of the invention comprises a first emission unit configured to emit a first light beam of a first wavelength, a second emission unit configured to emit a second light beam of a second wavelength which is longer than the first wavelength, a polarization unit configured to pass the first and second light beams emitted by the first and second emission units, and to polarize first and second reflected light beams obtained from an optical disk in correspondence with the first and second light beams, a focusing unit configured to focus the first and second light beams transmitted through the polarization unit on the optical disk, a detection unit configured to detect the first and second reflected light beams polarized by the polarization unit, a first diffraction unit, arranged on an optical path of the first and second light beams between the polarization unit and the focusing unit, configured to pass the first and second light beams, to diffract the first reflected light beam, and to pass the second reflected light beam, and a second diffraction unit, arranged on an optical path of the first and second light beams between the polarization unit and the detection unit, configured to pass the first reflected light beam and to diffract the second reflected light beam.

An optical head according to one aspect of the invention comprises an emission unit configured to emit a light beam, a first diffraction unit configured to diffract the light beam emitted by the emission unit, a polarization unit configured to pass one main beam and two sub beams formed by diffraction of the first diffraction unit, and to polarize a plurality of reflected light beams obtained from an optical disk in correspondence with these plurality of beams, a focusing unit configured to focus the plurality of beams transmitted through the polarization unit on the optical disk, a second diffraction unit configured to diffract a plurality of reflected light beams obtained from the optical disk in correspondence with the plurality of beams focused on the optical disk by the focusing unit, and a detection unit configured to detect components of the plurality of reflected light beams diffracted by the second diffraction unit, wherein the second diffraction unit extracts components of a main reflected light beam obtained from the optical disk in correspondence with the main beam, and components of two sub reflected light beams obtained from the optical disk in correspondence with the two sub beams, and the detection unit detects the components of the respective reflected light beams extracted by the second diffraction unit.

An optical disk drive according to one aspect of the invention comprises a first emission unit configured to emit a first light beam of a first wavelength, a second emission unit configured to emit a second light beam of a second wavelength which is longer than the first wavelength, a polarization unit configured to pass the first and second light beams emitted by the first and second emission units, and to polarize first and second reflected light beams obtained from an optical disk in correspondence with the first and second light beams, a focusing unit configured to focus the first and second light beams transmitted through the polarization unit on the optical disk, a detection unit configured to detect the first and second reflected light beams polarized by the polarization unit, a first diffraction unit, arranged on an optical path of the first and second light beams between the polarization unit and the focusing unit, configured to pass the first and second light beams, to diffract the first reflected light beam, and to pass the second reflected light beam, a second diffraction unit, arranged on an optical path of the first and second light beams between the polarization unit and the detection unit, configured to pass the first reflected light beam and to diffract the second reflected light beam, and a control unit configured to control tracking and focusing on the basis of components of the first reflected light beam which is diffracted by the first diffraction unit and detected by the detection unit, and to control tracking and focusing on the basis of components of the second reflected light beam which is diffracted by the second diffraction unit and detected by the detection unit.

An optical disk drive according to one aspect of the invention comprises an emission unit configured to emit a light beam, a first diffraction unit configured to diffract the light beam emitted by the emission unit, a polarization unit configured to pass one main beam and two sub beams formed by diffraction of the. first diffraction unit, and to polarize a plurality of reflected light beams obtained from an optical disk in correspondence with these plurality of beams, a focusing unit configured to focus the plurality of beams transmitted through the polarization unit on the optical disk, a second diffraction unit configured to diffract a plurality of reflected light beams obtained from the optical disk in correspondence with the plurality of beams focused on the optical disk by the focusing unit, a detection unit configured to detect components of the plurality of reflected light beams diffracted by the second diffraction unit, and a control unit configured to control tracking and focusing on the basis of the components of the reflected light beams detected by the detection unit, wherein the second diffraction unit extracts components of a main reflected light beam obtained from the optical disk in correspondence with the main beam, and components of two sub reflected light beams obtained from the optical disk in correspondence with the two sub beams, and the detection unit detects the components of the respective reflected light beams extracted by the second diffraction unit.

An optical system adjustment method according to one aspect of the invention for adjusting an optical system of an optical head, which comprises a first diffraction element for passing a second reflected light beam obtained from an optical disk in correspondence with a second light beam of first and second light beams having different wavelengths, and diffracting a first reflected light beam obtained from the optical disk in correspondence with the first light beam, a second diffraction element for passing a first reflected light obtained from the optical disk in correspondence with the first light beam and diffracting a second reflected light beam obtained from the optical disk in correspondence with the second light beam, and a photodetection element for detecting first diffracted light diffracted by the first diffraction element and second diffracted light diffracted by the second diffraction element, comprises adjusting a position of a light-receiving surface of the photodetection element with reference to the first diffracted light, and adjusting a direction of the second diffracted light by rotating the second diffraction element so that the second diffracted light which is polarized in accordance with rotation of the second diffraction element is received by the light-receiving surface, the position of which is adjusted.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a top view showing a schematic arrangement of an optical pickup head (optical head) according to the first embodiment of the present invention;

FIG. 2 is a side view showing an example of the optical pickup head shown in FIG. 1;

FIG. 3 shows an example of diffraction regions of a DVD diffraction optical element 108a;

FIG. 4 shows an example of a state of the DVD diffraction optical element 108a which is irradiated with reflected light;

FIG. 5 shows an example of diffraction regions of a CD diffraction optical element 109a;

FIG. 6 shows an example of a state of the CD diffraction optical element 109a which is irradiated with reflected light;

FIG. 7 shows an example of photodetection regions of a photodetection element 110a;

FIG. 8 shows another example of diffraction regions of the DVD diffraction optical element 108a;

FIG. 9 is a top view showing a schematic arrangement of an optical pickup head (optical head) according to the second and third embodiments of the present invention;

FIG. 10 is a side view showing an example of the optical pickup head shown in FIG. 9;

FIG. 11 shows an example of diffraction regions of a CD diffraction optical element 109b;

FIG. 12 shows an example of a state of the CD diffraction optical element 109b which is irradiated with reflected light;

FIG. 13 shows an example of photodetection regions of a photodetection element 110b;

FIG. 14 shows an example of photodetection regions of a photodetection element 110c;

FIG. 15 is a schematic diagram showing an example of the arrangement of an optical disk drive which mounts an optical pickup head 1;

FIG. 16 shows an overview of a 3-beam method; and

FIG. 17 is a flow chart showing an example of an optical system adjustment method.

### DETAILED DESCRIPTION OF THE INVENTION

Preferred embodiments of the present invention will be described hereinafter with reference to the accompanying drawings.

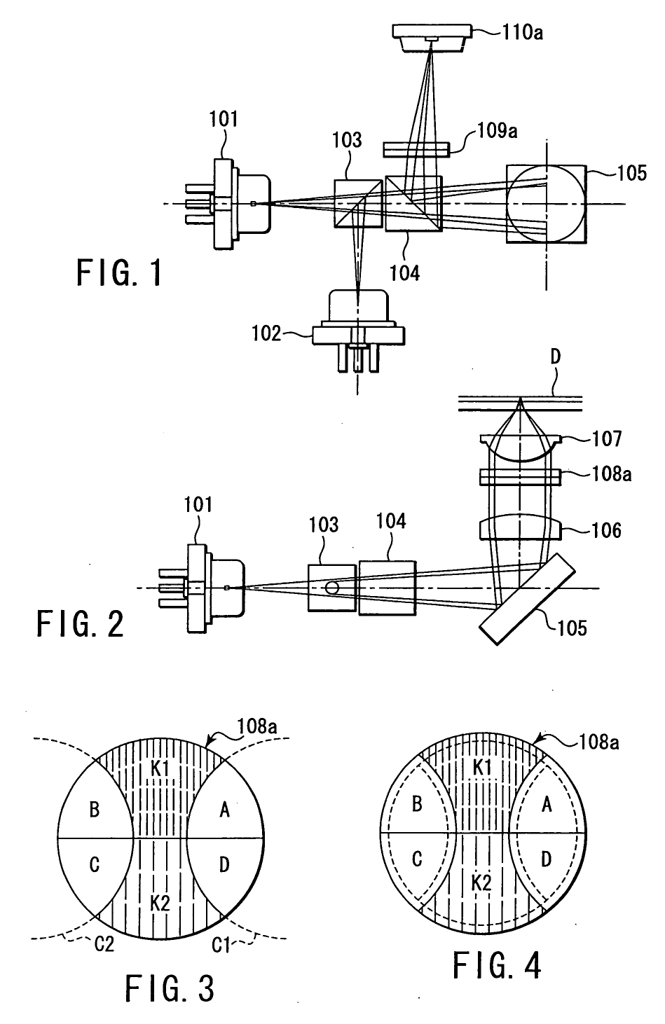

FIG. 1 is a top view showing a schematic arrangement of an optical pickup head (optical head) according to the first embodiment of the present invention. FIG. 2 is a side view of the optical pickup head shown in FIG. 1. In both the top view of FIG. 1 and the side view of FIG. 2, some building components are not illustrated for the purpose of easy viewing of the arrangement of an optical pickup head.

As shown in FIGS. 1 and 2, an optical pickup head comprises a DVD laser 101, CD laser 102, dichroic mirror 103, polarization beam splitter (PBS) 104, mirror 105, collimator lens 106, objective lens 107, DVD diffraction optical element (DVDHOE) 108a, CD diffraction optical element (CDHOE) 109a, and photodetection element (PD) 110a.

A case will be explained below wherein a DVD is to be processed. The DVD laser 101 emits a first light beam of a first wavelength (e.g., around 650 nm). The first light beam emitted by the DVD laser 101 is reflected by the dichroic mirror 103, and is transmitted through the polarization beam splitter 104. The first light beam that has been transmitted through the polarization beam splitter 104 is deflected upward by the mirror 105. The first light beam deflected upward by the mirror 105 is converted into collimated light by the collimator lens 106, is transmitted through the DVD diffraction optical element 108a, and is focused on the recording surface of an optical disk (DVD) by the objective lens 107. By focusing the light beam (focusing the first light beam with recording power), information can be recorded on the optical disk (DVD).

Furthermore, upon reproduction, light reflected by the optical disk, i.e., first reflected light obtained from the optical disk in correspondence with the first light beam, is totally diffracted by the DVD diffraction optical element 108a, and is polarized by the polarization beam splitter 104 via the collimator lens 106 and mirror 105. The first reflected light polarized by the polarization beam splitter 104 is transmitted through the CD diffraction optical element 109a and is detected by the photodetection element 110a. Diffraction of the first reflected light by the DVD diffraction optical element 108a and detection of the first reflected light by the photodetection element 110a will be described in detail later. Based on the first reflected light (reflected light of the first light beam with reproduction power) detected by the photodetection element 110a, information recorded on the optical disk (DVD) is reproduced, and tracking control and focusing control are attained. The tracking control and focusing control will also be described in detail later.

A case will be explained below wherein a CD is to be processed. The CD laser 102 emits a second light beam of a second wavelength (e.g., around 780 nm). The second light beam emitted by the CD laser 102 is reflected by the dichroic mirror 103, and is transmitted through the polarization beam splitter 104. The second light beam that has been transmitted through the polarization beam splitter 104 is deflected upward by the mirror 105. The second light beam deflected upward by the mirror 105 is converted into collimated light by the collimator lens 106, is transmitted through the DVD diffraction optical element 108a, and is focused on the recording surface of an optical disk (CD) by the objective lens 107. By focusing the light beam (focusing the second light beam with recording power), information can be recorded on the optical disk (CD).

Furthermore, upon reproduction, light reflected by the optical disk, i.e., second reflected light obtained from the optical disk in correspondence with the second light beam, is transmitted through the DVD diffraction optical element 108a, and is polarized by the polarization beam splitter 104 via the collimator lens 106 and mirror 105. The second reflected light polarized by the polarization beam splitter 104 is totally diffracted by the CD diffraction optical element 109a and is detected by the photodetection element 110a. Diffraction of the second reflected light by the CD diffraction optical element 109a and detection of the second reflected light by the photodetection element 110a will be described in detail later. Based on the second reflected light (reflected light of the second light beam with reproduction power) detected by the photodetection element 110a, information recorded on the optical disk (CD) is reproduced, and tracking control and focusing control are attained. The tracking control and focusing control will also be described in detail later.

As shown in FIGS. 1 and 2, the optical pickup head comprises the DVD diffraction optical element 108a inserted between the polarization beam splitter 104 and objective lens 107, and the CD diffraction optical element 109a inserted between the polarization beam splitter 104 and photodetection element 110a. In other words, the DVD diffraction optical element 108a is arranged below the objective lens 107a, and the CD diffraction optical element 109a is arranged in front of the photodetection element 110a. As described above, the DVD diffraction optical element 108a has a nature of totally diffracting reflected light from the DVD and allowing reflected light from the CD to pass through it. On the other hand, the CD diffraction optical element 109a has a nature of totally diffracting reflected light from the CD and allowing reflected light from the DVD to pass through it.

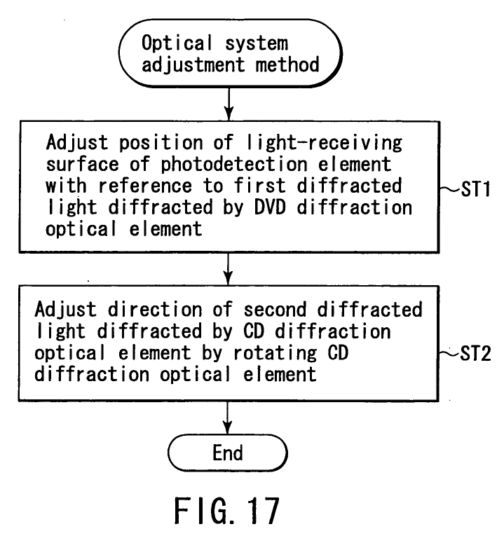

Adjustment of the optical system of the optical pickup head will be described below. FIG. 17 is a flow chart showing the aforementioned optical system adjustment method. The position of the light-receiving surface of the photodetection element 110a is adjusted with reference to first diffracted light diffracted by the DVD diffraction optical element 108a (ST1). When the CD diffraction optical element 109a rotates, second diffracted light diffracted by this CD diffraction optical element 109a is deflected in accordance with rotation. By exploiting this mechanism, the direction of the second diffracted light is adjusted by rotating the CD diffraction optical element 109a so that the second diffracted light is appropriately received by the light-receiving surface of the photodetection element 110a, whose position has been adjusted in ST1 (ST2). With this adjustment, the first diffracted light and second diffracted light can be appropriately received by the single photodetection element 110a.

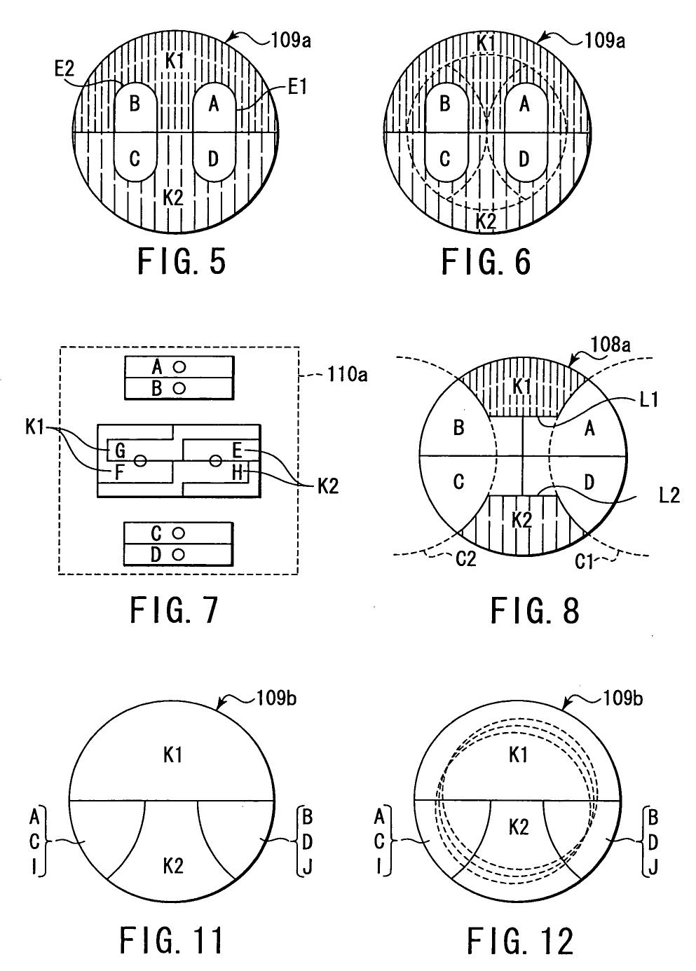

Details of the reflected light detection principle by the DVD diffraction optical element 108a, CD diffraction optical element 109a, and photodetection element 110a will be described below. FIG. 3 is a schematic view of diffraction regions of the DVD diffraction optical element 108a. FIG. 4 shows a state of the DVD diffraction optical element 108a which is irradiated with reflected light. FIG. 5 is a schematic view of diffraction regions of the CD diffraction optical element 109a. FIG. 6 shows a state of the CD diffraction optical element 109a which is irradiated with reflected light. FIG. 7 is a schematic view of photodetection regions of the photodetection element 110a.

As shown in FIGS. 3 and 4, the DVD diffraction optical element 108a comprises a first diffraction region A, second diffraction region D, third diffraction region B, fourth diffraction region C, fifth diffraction region K1, and sixth diffraction region K2. The DVD diffraction optical element 108a has a circular form, which is defined as a reference circle. First and second circles C1 and C2, which are two circles symmetric about the center of the reference circle, and have their centers located on the extended line of the diameter of the reference circle, are defined. One of the regions formed by dividing an overlapping region between the reference circle and first circle C1 by the diameter of the reference circle is the first diffraction region A, and the other region is the second diffraction region D. One of the regions formed by dividing an overlapping region between the reference circle and second circle C2 by the diameter of the reference circle is the third diffraction region B, and the other region is the fourth diffraction region C. Furthermore, one of the regions formed by dividing a non-overlapping region of the reference circle and the first and second circles C1 and C2 by the diameter of the reference circle is the fifth diffraction region K1, and the other region is the sixth diffraction region K2. The DVD diffraction optical element 108a extracts components of the first reflected light by the first diffraction region A, second diffraction region D, third diffraction region B, fourth diffraction region C, fifth diffraction region K1, and sixth diffraction region K2.

On the fifth diffraction region K1, diffraction gratings are formed at a first pitch (relatively small pitch). On the sixth diffraction region K2, diffraction gratings are formed at a second pitch (relatively large pitch) larger than the first pitch. For example, the second pitch is about 10μ. The diffraction gratings formed on the fifth and sixth diffraction regions K1 and K2 are specified by pitches, which are formed in a direction perpendicular to the diameter of the reference circle, as shown in FIG. 3.

As shown in FIGS. 5 and 6, the CD diffraction optical element 109a comprises a first diffraction region A, second diffraction region D, third diffraction region B, fourth diffraction region C, fifth diffraction region K1, and sixth diffraction region K2. The CD diffraction optical element 109a has a circular form, which is defined as a reference circle. First and second symmetric regions E1 and E2, which are included in this reference circle and are symmetric about the center and diameter of the reference circle, are defined. One of the regions formed by dividing the first symmetric region E1 by the diameter of the reference circle is the first diffraction region A, and the other region is the second diffraction region D. One of the regions formed by dividing the second symmetric region E2 by the diameter of the reference circle is the third diffraction region B, and the other region is the fourth diffraction region C. One of the regions formed by dividing a non-overlapping region of the reference circle and the first and second symmetric regions E1 and E2 by the diameter of the reference circle is the fifth diffraction region K1, and the other region is the sixth diffraction region K2. The CD diffraction optical element 109a extracts components of the second reflected light by the first diffraction region A, second diffraction region D, third diffraction region B, fourth diffraction region C, fifth diffraction region K1, and sixth diffraction region K2.

On the fifth diffraction region K1, diffraction gratings are formed at a first pitch. On the sixth diffraction region K2, diffraction gratings are formed at a second pitch larger than the first pitch. The diffraction gratings formed on the fifth and sixth diffraction regions K1 and K2 are specified by pitches, which are formed in a direction perpendicular to the diameter of the reference circle, as shown in FIG. 5.

As shown in FIG. 7, the photodetection element 110a comprises detection regions A, B, C, D, E, F, G, and H. The first diffraction regions A of the DVD and CD diffraction optical elements 108a and 109a correspond to the detection region A of the photodetection element 110a. That is, first reflected light components diffracted by the first diffraction region A of the DVD diffraction optical element 108a or second reflected light components diffracted by the first diffraction region A of the CD diffraction optical element 109a are detected by the detection region A of the photodetection element 110a.

The third diffraction regions B of the DVD and CD diffraction optical elements 108a and 109a correspond to the detection region B of the photodetection element 110a. That is, first reflected light components diffracted by the third diffraction region B of the DVD diffraction optical element 108a or second reflected light components diffracted by the third diffraction region B of the CD diffraction optical element 109a are detected by the detection region B of the photodetection element 110a.

The fourth diffraction regions C of the DVD and CD diffraction optical elements 108a and 109a correspond to the detection region C of the photodetection element 110a. That is, first reflected light components diffracted by the fourth diffraction region C of the DVD diffraction optical element 108a or second reflected light components diffracted by the fourth diffraction region C of the CD diffraction optical element 109a are detected by the detection region C of the photodetection element 110a.

The second diffraction regions D of the DVD and CD diffraction optical elements 108a and 109a correspond to the detection region D of the photodetection element 110a. That is, first reflected light components diffracted by the second diffraction region D of the DVD diffraction optical element 108a or second reflected light components diffracted by the second diffraction region D of the CD diffraction optical element 109a are detected by the detection region D of the photodetection element 110a.

The fifth diffraction regions K1 of the DVD and CD diffraction optical elements 108a and 109a correspond to the detection regions F and G of the photodetection element 110a. That is, first reflected light diffracted by the fifth diffraction region K1 (diffraction gratings at the first pitch) of the DVD diffraction optical element 108a or second reflected light diffracted by the fifth diffraction region K1 (diffraction gratings at the first pitch) of the CD diffraction optical element 109a is guided to the detection regions F and G of the photodetection element 110a by the diffraction gratings formed on the fifth diffraction regions K1, and these first or second reflected light components are detected by the detection regions F and G of the photodetection element 110a. More specifically, reflected light diffracted by the fifth diffraction region K1 is focused on the boundary between the detection regions F and G. That is, the detection result of the first reflected light on the detection regions F and G changes in correspondence with rotation of the DVD diffraction optical element 108a. Likewise, the detection result of the second reflected light on the detection regions F and G changes in correspondence with rotation of the CD diffraction optical element 109a.

The sixth diffraction regions K2 of the DVD and CD diffraction optical elements 108a and 109a correspond to the detection regions E and H of the photodetection element 110a. That is, first reflected light diffracted by the sixth diffraction region K2 (diffraction gratings at the second pitch) of the DVD diffraction optical element 108a or second reflected light diffracted by the sixth diffraction region K2 (diffraction gratings at the second pitch) of the CD diffraction optical element 109a is guided to the detection regions E and H of the photodetection element 110a by the diffraction gratings formed on the sixth diffraction regions K2, and these first or second reflected light components are detected by the detection regions E and H of the photodetection element 110a. More specifically, reflected light diffracted by the sixth diffraction region K2 is focused on the boundary between the detection regions E and H. That is, the detection result of the first reflected light on the detection regions E and H changes in correspondence with rotation of the DVD diffraction optical element 108a. Likewise, the detection result of the second reflected light on the detection regions E and H changes in correspondence with rotation of the CD diffraction optical element 109a.

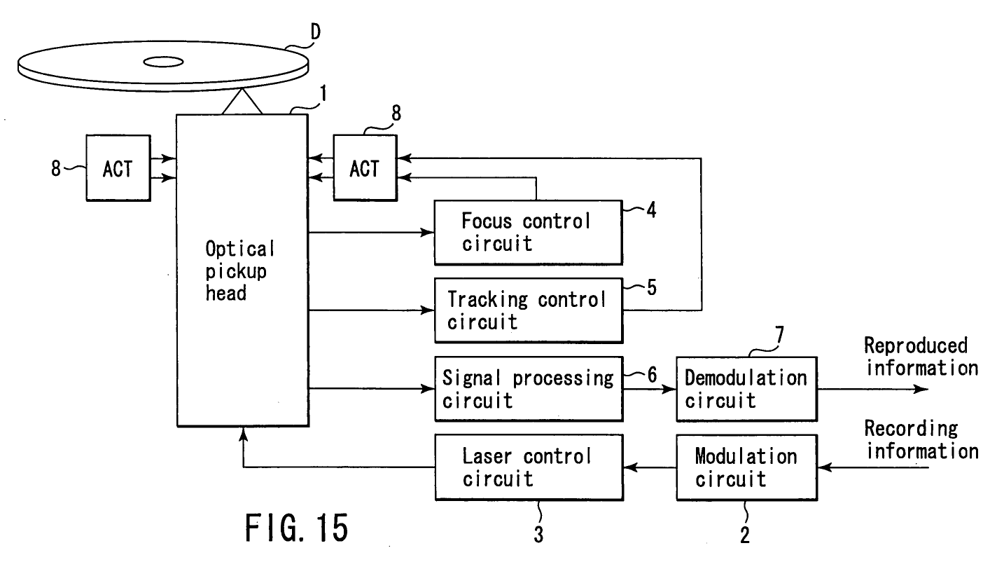

FIG. 15 is a schematic diagram showing the arrangement of an optical disk drive which mounts the aforementioned optical pickup head. This optical disk drive records target data on an optical disk D such as a DVD or CD, and reproduces data recorded on this optical disk D.

As shown in FIG. 15, the optical disk drive comprises an optical pickup head 1, modulation circuit 2, laser control circuit 3, focus control circuit 4, tracking control circuit 5, signal processing circuit 6, demodulation circuit 7, and actuator 8.

A data recording process on the optical disk D by this optical disk drive will be explained first. A recording signal is modulated to a signal of a predetermined channel bit sequence by the modulation circuit 2. The channel bit sequence corresponding to the recording signal is converted into a laser drive waveform by the laser control circuit 3. The laser control circuit 3 pulse-drives the DVD laser 101 or CD laser 102 to make it emit a light beam with recording power. As a result, the light beam with recording power is focused on an information recording surface of the optical disk D, and target data is recorded on the optical disk D. At this time, the recording light beam focused on the optical disk D is maintained in a state wherein it can form a best small spot on the recording surface, under the focus control of the focus control circuit 4 and the tracking control of the tracking control circuit 5.

Next, reproduction of data recorded on the optical disk D by this optical disk drive will be explained. The laser control circuit 3 drives the DVD laser 101 or CD laser 102 on the basis of a data reproduction instruction to make it emit a light beam with reproduction power. As a result, the light beam with reproduction power is focused on the information recording surface of the optical disk D. The light beam with reproduction power focused on the optical disk D is maintained in a state wherein it can form a best small spot on the recording surface, under the focus control of the focus control circuit 4 and the tracking control of the tracking control circuit 5. At this time, the light beam with reproduction power, which strikes the optical disk D, is reflected by a reflection film or reflective recording film in the information recording surface. The reflected light is diffracted by the DVD diffraction optical element 108a or CD diffraction optical element 109a, and is detected by the photodetection element 110a.

A focus error signal (FES), tracking error signal (TES), and reproduction signal (RF) are generated on the basis of the reflected light components detected by the respective detection regions of the photodetection element 110a by:
FES=(E+F)−(G+H) (1)
TES(push-pull)=(B+C)−(A+D) (2)
TES(DPD)=ph(A+C)−ph(B+D) (3)
RF=A+B+C+D+E+F+G+H (4)
Note that the focus error detection adopts the double knife edge method. That is, the fifth and sixth diffraction regions K1 and K2 extract reflected light limited by double knife edges.

The focus control circuit 4 outputs, to the actuator 8, a focus control signal used to correct any focus error on the basis of the focus error signal generated by equation (1). The tracking control circuit 5 outputs, to the actuator 8, a tracking control signal used to correct any tracking error on the basis of the tracking error signal generated by equation (2) or (3). The signal processing circuit 6 equalizes the reproduction signal generated by equation (4) to form a binary reproduction signal. Furthermore, the demodulation circuit 7 demodulates the binary reproduction signal by a demodulation method corresponding to a predetermined modulation method.

In the above description, the DVD diffraction optical element 108a having the diffraction regions shown in FIG. 3 has been exemplified. However, the present invention is not limited to such specific element, and may be applied to a DVD diffraction optical element 108a having diffraction regions shown in, e.g., FIG. 8.

As shown in FIG. 8, the DVD diffraction optical element 108a comprises a first diffraction region A, second diffraction region D, third diffraction region B, fourth diffraction region C, fifth diffraction region K1, and sixth diffraction region K2. The DVD diffraction optical element 108a has a circular form, which is defined as a reference circle. First and second circles C1 and C2, which are two circles symmetric about the center of the reference circle, and have their centers located on the extended line of the diameter of the reference circle, are defined. Furthermore, two line segments L1 and L2, which are parallel to the diameter of the reference circle and are symmetric about the center of the reference circle, are defined. One line segment L1 connects one point on the circumference of the first circle C1 and that on the circumference of the second circle C2. The other line segment L2 connects one point on the circumference of the first circle C1 and that on the circumference of the second circle C2. In one of the regions which are formed by dividing a non-overlapping region of the reference circle and the first and second circles C1 and C2 by the diameter of the reference circle, a region, which is further defined by the line segment L1 and an arc of the reference circle, is the fifth diffraction region K1. In the other of the regions which are formed by dividing the non-overlapping region of the reference circle and the first and second circles C1 and C2 by the diameter of the reference circle, a region, which is further defined by the line segment L2 and an arc of the reference circle, is the sixth diffraction region K2. Four regions formed by dividing a region, which is formed by excluding the fifth and sixth diffraction regions K1 and K2 from a region defined by the reference circle, by the diameter of the reference circle and a line segment perpendicular to this diameter are defined as the first diffraction region A, second diffraction region D, third diffraction region B, and fourth diffraction region C. Note that the first diffraction region A includes one of the regions which are formed by dividing an overlapping region between the reference circle and first circle C1 by the diameter of the reference circle. The second diffraction region D includes the other of the regions which are formed by dividing the overlapping region between the reference circle and first circle C1 by the diameter of the reference circle. The third diffraction region B includes one of the regions which are formed by dividing an overlapping region between the reference circle and second circle C2 by the diameter of the reference circle. The fourth diffraction region C includes the other of the regions which are formed by dividing the overlapping region between the reference circle and first circle C2 by the diameter of the reference circle. The DVD diffraction optical element 108a extracts components of the first reflected light by the first diffraction region A, second diffraction region D, third diffraction region B, fourth diffraction region C, fifth diffraction region K1, and sixth diffraction region K2.

On the fifth diffraction region K1, diffraction gratings are formed at a first pitch (relatively small pitch). On the sixth diffraction region K2, diffraction gratings are formed at a second pitch (relatively large pitch) larger than the first pitch. For example, the second pitch is about 10μ. The diffraction gratings formed on the fifth and sixth diffraction regions K1 and K2 are specified by pitches, which are formed in a direction perpendicular to the diameter of the reference circle, as shown in FIG. 3.

As described above, only one photodetection element 110a can detect focus error signals for the CD and DVD by the knife edge method without arranging any independent photodetection elements for the CD and DVD. Furthermore, the single photodetection element 110a can also detect tracking error signals (push-pull, DPD).

The second and third embodiments will be described below. Note that a description about components common to those in the first embodiment will be omitted.

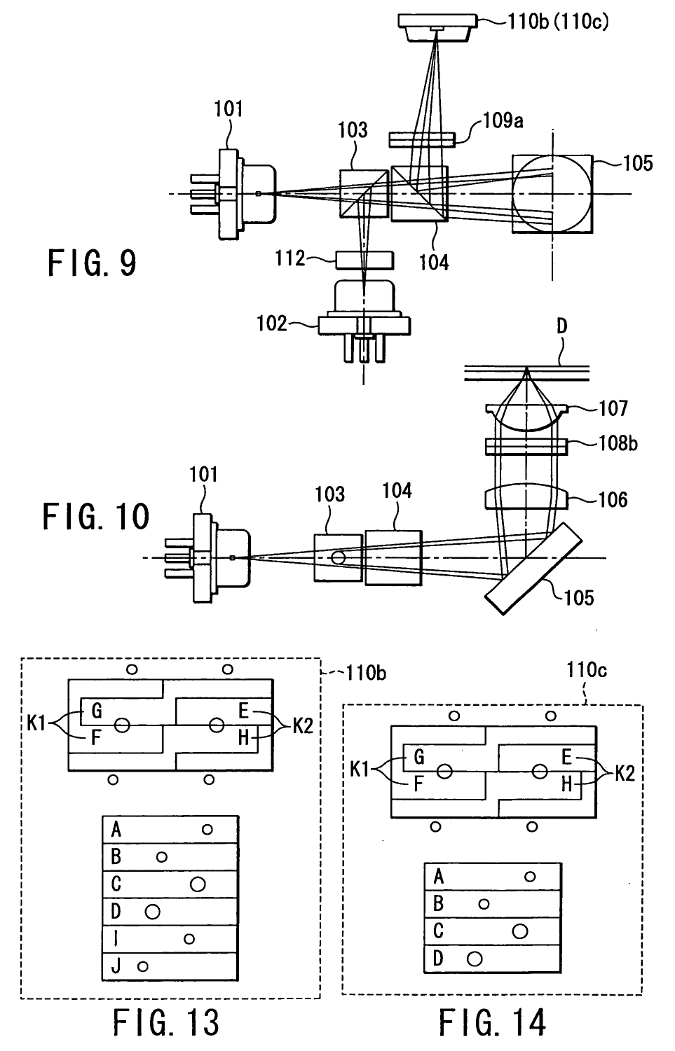

FIG. 9 is a top view showing a schematic arrangement of an optical pickup head (optical head) according to the second and third embodiments of the present invention. FIG. 10 is a side view of the optical pickup head shown in FIG. 9. In both the top view of FIG. 9 and the side view of FIG. 10, some building components are not illustrated for the purpose of easy viewing of the arrangement of an optical pickup head.

As shown in FIGS. 9 and 10, an optical pickup head according to the second embodiment comprises a DVD laser 101, CD laser 102, dichroic mirror 103, polarization beam splitter (PBS) 104, mirror 105, collimator lens 106, objective lens 107, DVD diffraction optical element (DVDHOE) 108b, CD diffraction optical element (CDHOE) 109b, photodetection element (PD) 110b, and diffraction grating 112. On the other hand, an optical pickup head according to the third embodiment comprises a photodetection element (PD) 110c in place of the photodetection element (PD) 110b.

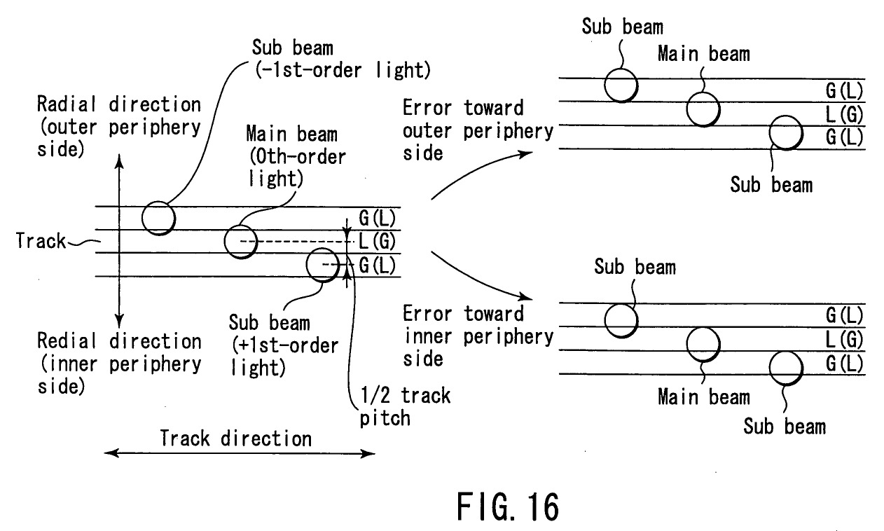

The second and third embodiments are directed to reflected light detection (tracking error detection) using a 3-beam method. An overview of the 3-beam method will be explained below with reference to FIG. 16. The 3-beam method detects reflected light using one main beam (0th-order light) and two sub beams (±1st-order light). On an optical disk, tracks are formed along the circumferential direction of the disk. For example, land tracks (L) and groove tracks (G) are alternately formed every round of the disk. Hence, land tracks (L) and groove tracks (G) alternate, as shown in FIG. 16, when viewed in the radial direction. Three beams emitted by the optical pickup head are shifted ½ track pitches in the radial direction, and are focused on the disk in the order of sub beam (−1st-order light), main beam (0th-order light), and sub beam (+1st-order light). Furthermore, these three beams are also equally spaced apart in the track direction, and are focused on the disk in the order of sub beam, main beam, and sub beam. The three beams do not overlap each other. For example, the main beam traces the center of a land track (or groove track), one sub beam traces the center of a groove track (or land track) which neighbors that land track (or groove track) on the outer periphery side, and the other sub beam traces the center of a groove track (or land track) which neighbors that land track (or groove track) on the inner periphery side. A track error amount can be detected from the trace states of the two sub beams.

Note that a second light beam emitted by the CD laser 102 is split into one main beam and two sub beams by the diffraction grating 112.

Details of the reflected light detection principle by the CD diffraction optical element 109b and photodetection element 110b or 110c will be described below. FIG. 11 is a schematic view of diffraction regions of the CD diffraction optical element 109b. FIG. 12 shows a state of the CD diffraction optical element 109b which is irradiated with reflected light. FIG. 13 is a schematic view of photodetection regions of the photodetection element 110b. FIG. 14 is a schematic view of photodetection regions of the photodetection element 110c.

As shown in FIGS. 11 and 12, the CD diffraction optical element 109b comprises first diffraction regions A, C, and I, second diffraction regions B, D, and J, third diffraction region K1, and fourth diffraction region K2. The CD diffraction optical element 109b has a circular form, which is defined as a reference circle. One divided region of the reference circle equally divided by the diameter of this reference circle is defined as a first divided region, and the other divided region is defined as a second divided region. Furthermore, first and second circles, which are two circles symmetric about the center of the reference circle, and have their centers located on the extended line of the diameter of the reference circle, are defined. An overlapping region between the second divided region and first circle corresponds to the first diffraction regions A, C, and I. An overlapping region between the second divided region and second circle corresponds to the second diffraction regions B, D, and J. The first divided region corresponds to the third diffraction region K1, and a non-overlapping region with the first and second circles in the second divided region corresponds to the fourth diffraction region K2. The CD diffraction optical element 109b extracts main reflected light components of the main beam by the first diffraction region A, second diffraction region B, third diffraction region K1, and fourth diffraction region K2. Likewise, the CD diffraction optical element 109b extracts sub reflected light components of one sub beam by the first diffraction region C, second diffraction region D, third diffraction region K1, and fourth diffraction region K2. Also, the CD diffraction optical element 109b extracts sub reflected light components of the other sub beam by the first diffraction region I, second diffraction region J, third diffraction region K1, and fourth diffraction region K2.

As shown in FIG. 13, the photodetection element 110b comprises detection regions A, B, C, D, E, F, G, H, I, and J. The first diffraction regions A of the CD diffraction optical element 109b corresponds to the detection region A of the photodetection element 110b. That is, main reflected light components diffracted by the first diffraction region A of the CD diffraction optical element 109b are detected by the detection region A of the photodetection element 110b.

The second diffraction region B of the CD diffraction optical element 109b corresponds to the detection region B of the photodetection element 110b. That is, main reflected light components diffracted by the second diffraction region B of the CD diffraction optical element 109b are detected by the detection region B of the photodetection element 110b.

The first diffraction regions C of the CD diffraction optical element 109b corresponds to the detection region C of the photodetection element 110b. That is, sub reflected light components diffracted by the first diffraction region C of the CD diffraction optical element 109b are detected by the detection region C of the photodetection element 110b.

The second diffraction region D of the CD diffraction optical element 109b corresponds to the detection region D of the photodetection element 110b. That is, sub reflected light components diffracted by the second diffraction region D of the CD diffraction optical element 109b are detected by the detection region D of the photodetection element 110b.

The first diffraction regions I of the CD diffraction optical element 109b corresponds to the detection region I of the photodetection element 110b. That is, sub reflected light components diffracted by the first diffraction region I of the CD diffraction optical element 109b are detected by the detection region I of the photodetection element 110b.

The second diffraction region J of the CD diffraction optical element 109b corresponds to the detection region J of the photodetection element 110b. That is, sub reflected light components diffracted by the second diffraction region J of the CD diffraction optical element 109b are detected by the detection region J of the photodetection element 110b.

The third diffraction region K1 of the CD diffraction optical element 109b corresponds to the detection regions F and G of the photodetection element 110b. That is, main reflected light components diffracted by the third diffraction region K1 of the CD diffraction optical element 109b are detected by the detection regions F and G of the photodetection element 110b. More specifically, main reflected light diffracted by the third diffraction region K1 is focused on the boundary between the detection regions F and G. That is, the detection result of the main reflected light on the detection regions F and G changes in correspondence with rotation of the CD diffraction optical element 109b.

The fourth diffraction region K2 of the CD diffraction optical element 109b corresponds to the detection regions E and H of the photodetection element 110b. That is, main reflected light components diffracted by the fourth diffraction region K2 of the CD diffraction optical element 109b are detected by the detection regions E and H of the photodetection element 110b. More specifically, main reflected light diffracted by the fourth diffraction region K2 is focused on the boundary between the detection regions E and H. That is, the detection result of the main reflected light on the detection regions E and H changes in correspondence with rotation of the CD diffraction optical element 109b.

A focus error signal (FES), tracking error signal (TES), and reproduction signal (RF) are generated on the basis of the reflected light components detected by the respective detection regions of the photodetection element 110b by:
FES=(E+F)−(G+H) (5)
TES(push-pull)=(C−D)−K*(A+I−(B+J)) (6)
TES(DPD)=ph(C)−ph(D) (7)
RF=C+D+E+F+G+H (8)
Note that the focus error detection adopts the double knife edge method. That is, the third and fourth diffraction regions K1 and K2 extract reflected light limited by double knife edges.

The focus control circuit 4 outputs, to the actuator 8, a focus control signal used to correct any focus error on the basis of the focus error signal generated by equation (5). The tracking control circuit 5 outputs, to the actuator 8, a tracking control signal used to correct any tracking error on the basis of the tracking error signal generated by equation (6) or (7). The signal processing circuit 6 equalizes the reproduction signal generated by equation (8) to form a binary reproduction signal. Furthermore, the demodulation circuit 7 demodulates the binary reproduction signal by a demodulation method corresponding to a predetermined modulation method.

Subsequently, the photodetection element 110c adopted in the optical pickup according to the third embodiment will be explained. As shown in FIG. 14, the photodetection element 110c comprises detection regions A, B, C, D, E, F, G, and H. That is, the presence/absence of the detection regions I and J is the difference between the photodetection elements 110b and 110c. The photodetection element 110c detects reflected light of only one of the two sub beams. A focus error signal (FES), tracking error signal (TES), and reproduction signal (RF) are generated on the basis of the reflected light components detected by the respective detection regions of the photodetection element 110c by:
FES=(E+F)−(G+H) (9)
TES(push-pull)=(C−D)−K*(A−B) (10)
TES(DPD)=ph(C)−ph(D) (11)
RF=C+D+E+F+G+H (12)

The focus control circuit 4 outputs, to the actuator 8, a focus control signal used to correct any focus error on the basis of the focus error signal generated by equation (9). The tracking control circuit 5 outputs, to the actuator 8, a tracking control signal used to correct any tracking error on the basis of the tracking error signal generated by equation (10) or (11). The signal processing circuit 6 equalizes the reproduction signal generated by equation (12) to form a binary reproduction signal. Furthermore, the demodulation circuit 7 demodulates the binary reproduction signal by a demodulation method corresponding to a predetermined modulation method.

As described above, by devising the extraction regions (diffraction regions) of reflected light by the CD diffraction optical element 109b, focus error signal detection and tracking error signal detection (push-pull, DPD) can be attained by the knife edge (double knife edge) method. That is, one CD diffraction optical element 109b and one photodetection element 110b or 110c can achieve focus error signal detection and tracking error signal detection (push-pull, DPD) based on the knife edge method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical head comprising:
a first emission unit configured to emit a first light beam of a first wavelength;
a second emission unit configured to emit a second light beam of a second wavelength which is longer than the first wavelength;
a polarization unit configured to pass the first and second light beams emitted by the first and second emission units, and to polarize first and second reflected light beams obtained from an optical disk in correspondence with the first and second light beams;
a focusing unit configured to focus the first and second light beams transmitted through the polarization unit on the optical disk;
a detection unit configured to detect the first and second reflected light beams polarized by the polarization unit;
a first diffraction unit, arranged on an optical path of the first and second light beams between the polarization unit and the focusing unit, configured to pass the first and second light beams, to diffract the first reflected light beam, and to pass the second reflected light beam; and
a second diffraction unit, arranged on an optical path of the first and second light beams between the polarization unit and the detection unit, configured to pass the first reflected light beam and to diffract the second reflected light beam.

2. An optical head according to claim 1, wherein the first diffraction unit has a circular form, which is defined as a reference circle, first and second circles, which are two circles symmetric about a center of the reference circle and have centers located on an extended line of a diameter of the reference circle, are defined, one of regions formed by dividing an overlapping region between the reference circle and the first circle by the diameter of the reference circle is defined as a first diffraction region and the other region is defined as a second diffraction region, one of regions formed by dividing an overlapping region between the reference circle and the second circle by the diameter of the reference circle is defined as a third diffraction region and the other region is defined as a fourth diffraction region, one of regions formed by dividing a non-overlapping region of the reference circle and the first and second circles by the diameter of the reference circle is defined as a fifth diffraction region and the other region is defined as a sixth diffraction region, and the first diffraction unit extracts components of the first reflected light beam by the first, second, third, fourth, fifth, and sixth diffraction regions, and
the detection unit independently detects the components of the first reflected light beam extracted by the first, second, third, fourth, fifth, and sixth diffraction regions.

3. An optical head according to claim 2, wherein the detection unit detects components of the first reflected light beam extracted by the fifth diffraction region by first and second detection regions, and detects components of the first reflected light beam extracted by the sixth diffraction region by third and fourth detection regions.

4. An optical head according to claim 1, wherein the second diffraction unit has a circular form, which is defined as a reference circle, first and second symmetric regions, which are included in the reference circle and are symmetric about a center and diameter of the reference circle, are defined, one of regions formed by dividing the first symmetric region by the diameter of the reference circle is defined as a first diffraction region and the other region is defined as a second diffraction region, one of regions formed by dividing the second symmetric region by the diameter of the reference circle is defined as a third diffraction region and the other region is defined as a fourth diffraction region, one of regions formed by dividing a non-overlapping region of the reference circle and the first and second symmetric regions by the diameter of the reference circle is defined as a fifth diffraction region and the other region is defined as a sixth diffraction region, and the second diffraction unit extracts components of the second reflected light beam by the first, second, third, fourth, fifth, and sixth diffraction regions, and
the detection unit independently detects the components of the second reflected light beam extracted by the first, second, third, fourth, fifth, and sixth diffraction regions.

5. An optical head according to claim 4, wherein the detection unit detects components of the second reflected light beam extracted by the fifth diffraction region by first and second detection regions, and detects components of the second reflected light beam extracted by the sixth diffraction region by third and fourth detection regions.

6. An optical head comprising:
an emission unit configured to emit a light beam;
a first diffraction unit configured to diffract the light beam emitted by the emission unit;
a polarization unit configured to pass one main beam and two sub beams formed by diffraction of the first diffraction unit, and to polarize a plurality of reflected light beams obtained from an optical disk in correspondence with these plurality of beams;
a focusing unit configured to focus the plurality of beams transmitted through the polarization unit on the optical disk;
a second diffraction unit configured to diffract a plurality of reflected light beams obtained from the optical disk in correspondence with the plurality of beams focused on the optical disk by the focusing unit; and
a detection unit configured to detect components of the plurality of reflected light beams diffracted by the second diffraction unit,
wherein the second diffraction unit extracts components of a main reflected light beam obtained from the optical disk in correspondence with the main beam, and components of two sub reflected light beams obtained from the optical disk in correspondence with the two sub beams, and
the detection unit detects the components of the respective reflected light beams extracted by the second diffraction unit.

7. An optical head according to claim 6, wherein the second diffraction unit has a circular form, which is defined as a reference circle, one of divided regions, which are formed by equally dividing the reference circle by a diameter thereof, is defined as a first divided region and the other divided region is defined as a second divided region, first and second circles, which are two circles symmetric about a center of the reference circle and have centers located on an extended line of a diameter of the reference circle, are defined, an overlapping region between the second divided region and the first circle is defined as a first diffraction region, an overlapping region between the second divided region and the second circle is defined as a second diffraction region, the first divided region is defined as a third diffraction region, a non-overlapping region of the first and second circles in the second divided region is defined as a fourth diffraction region, and the second diffraction unit extracts components of the main reflected light beam and components of the two sub reflected light beams by the first, second, third, and fourth diffraction regions, and
the detection unit detects the components of the main reflected light beam, and the components of one of the two sub reflected light beams from components of the reflected light beams extracted by the first, second, third, and fourth diffraction regions.

8. An optical head according to claim 6, wherein the second diffraction unit has a circular form, which is defined as a reference circle, one of divided regions, which are formed by equally dividing the reference circle by a diameter thereof, is defined as a first divided region and the other divided region is defined as a second divided region, first and second circles, which are two circles symmetric about a center of the reference circle and have centers located on an extended line of a diameter of the reference circle, are defined, an overlapping region between the second divided region and the first circle is defined as a first diffraction region, an overlapping region between the second divided region and the second circle is defined as a second diffraction region, the first divided region is defined as a third diffraction region, a non-overlapping region of the first and second circles in the second divided region is defined as a fourth diffraction region, and the second diffraction unit extracts components of the main reflected light beam and components of the two sub reflected light beams by the first, second, third, and fourth diffraction regions, and
the detection unit detects the components of the main reflected light beam, and the components of the two sub reflected light beams from components of the reflected light beams extracted by the first, second, third, and fourth diffraction regions.

9. An optical disk drive comprising:
a first emission unit configured to emit a first light beam of a first wavelength;
a second emission unit configured to emit a second light beam of a second wavelength which is longer than the first wavelength;
a polarization unit configured to pass the first and second light beams emitted by the first and second emission units, and to polarize first and second reflected light beams obtained from an optical disk in correspondence with the first and second light beams;
a focusing unit configured to focus the first and second light beams transmitted through the polarization unit on the optical disk;
a detection unit configured to detect the first and second reflected light beams polarized by the polarization unit;
a first diffraction unit, arranged on an optical path of the first and second light beams between the polarization unit and the focusing unit, configured to pass the first and second light beams, to diffract the first reflected light beam, and to pass the second reflected light beam;
a second diffraction unit, arranged on an optical path of the first and second light beams between the polarization unit and the detection unit, configured to pass the first reflected light beam and to diffract the second reflected light beam; and
a control unit configured to control tracking and focusing on the basis of components of the first reflected light beam which is diffracted by the first diffraction unit and detected by the detection unit, and to control tracking and focusing on the basis of components of the second reflected light beam which is diffracted by the second diffraction unit and detected by the detection unit.

10. An optical disk drive according to claim 9, wherein the first diffraction unit has a circular form, which is defined as a reference circle, first and second circles, which are two circles symmetric about a center of the reference circle and have centers located on an extended line of a diameter of the reference circle, are defined, one of regions formed by dividing an overlapping region between the reference circle and the first circle by the diameter of the reference circle is defined as a first diffraction region and the other region is defined as a second diffraction region, one of regions formed by dividing an overlapping region between the reference circle and the second circle by the diameter of the reference circle is defined as a third diffraction region and the other region is defined as a fourth diffraction region, one of regions formed by dividing a non-overlapping region of the reference circle and the first and second circles by the diameter of the reference circle is defined as a fifth diffraction region and the other region is defined as a sixth diffraction region, and the first diffraction unit extracts components of the first reflected light beam by the first, second, third, fourth, fifth, and sixth diffraction regions,
the detection unit independently detects the components of the first reflected light beam extracted by the first, second, third, fourth, fifth, and sixth diffraction regions,
the control unit controls tracking on the basis of a tracking error signal generated from a difference between a sum signal of the components of the first reflected light beam obtained from the third and fourth diffraction regions, and a sum signal of the components of the first reflected light beam obtained from the first and second diffraction regions,
the detection unit detects the first reflected light beam extracted by the fifth diffraction region by first and second detection regions, and detects the first reflected light beam extracted by the sixth diffraction region by third and fourth detection regions, and
the control unit controls focusing on the basis of a focus error signal generated from a difference between a sum signal of the components of the first reflected light beam detected by the second and third detection regions and a sum signal of the components of the first reflected light beam detected by the first and fourth detection regions.

11. An optical disk drive according to claim 9, wherein the first diffraction unit has a circular form, which is defined as a reference circle, first and second circles, which are two circles symmetric about a center of the reference circle and have centers located on an extended line of a diameter of the reference circle, are defined, one of regions formed by dividing an overlapping region between the reference circle and the first circle by the diameter of the reference circle is defined as a first diffraction region and the other region is defined as a second diffraction region, one of regions formed by dividing an overlapping region between the reference circle and the second circle by the diameter of the reference circle is defined as a third diffraction region and the other region is defined as a fourth diffraction region, one of regions formed by dividing a non-overlapping region of the reference circle and the first and second circles by the diameter of the reference circle is defined as a fifth diffraction region and the other region is defined as a sixth diffraction region, and the first diffraction unit extracts components of the first reflected light beam by the first, second, third, fourth, fifth, and sixth diffraction regions,
the detection unit independently detects the components of the first reflected light beam extracted by the first, second, third, fourth, fifth, and sixth diffraction regions,
the control unit controls tracking on the basis of a tracking error signal generated from a difference between a sum signal of the components of the first reflected light beam obtained from the first and fourth diffraction regions, and a sum signal of the components of the first reflected light beam obtained from the second and third diffraction regions,
the detection unit detects the first reflected light beam extracted by the fifth diffraction region by first and second detection regions, and detects the first reflected light beam extracted by the sixth diffraction region by third and fourth detection regions, and
the control unit controls focusing on the basis of a focus error signal generated from a difference between a sum signal of the components of the first reflected light beam detected by the second and third detection regions and a sum signal of the components of the first reflected light beam detected by the first and fourth detection regions.

12. An optical disk drive according to claim 9, wherein the second diffraction unit has a circular form, which is defined as a reference circle, first and second symmetric regions, which are included in the reference circle and are symmetric about a center and diameter of the reference circle, are defined, one of regions formed by dividing the first symmetric region by the diameter of the reference circle is defined as a first diffraction region and the other region is defined as a second diffraction region, one of regions formed by dividing the second symmetric region by the diameter of the reference circle is defined as a third diffraction region and the other region is defined as a fourth diffraction region, one of regions formed by dividing a non-overlapping region of the reference circle and the first and second symmetric regions by the diameter of the reference circle is defined as a fifth diffraction region and the other region is defined as a sixth diffraction region, and the second diffraction unit extracts components of the second reflected light beam by the first, second, third, fourth, fifth, and sixth diffraction regions,
the detection unit independently detects the components of the second reflected light beam extracted by the first, second, third, fourth, fifth, and sixth diffraction regions,
the control unit controls tracking on the basis of a tracking error signal generated from a difference between a sum signal of the components of the second reflected light beam obtained from the third and fourth diffraction regions, and a sum signal of the components of the second reflected light beam obtained from the first and second diffraction regions,
the detection unit detects the second reflected light beam extracted by the fifth diffraction region by first and second detection regions, and detects the second reflected light beam extracted by the sixth diffraction region by third and fourth detection regions, and
the control unit controls focusing on the basis of a focus error signal generated from a difference between a sum signal of the components of the second reflected light beam detected by the second and third detection regions and a sum signal of the components of the second reflected light beam detected by the first and fourth detection regions.

13. An optical disk drive according to claim 9, wherein the second diffraction unit has a circular form, which is defined as a reference circle, first and second symmetric regions, which are included in the reference circle and are symmetric about a center and diameter of the reference circle, are defined, one of regions formed by dividing the first symmetric region by the diameter of the reference circle is defined as a first diffraction region and the other region is defined as a second diffraction region, one of regions formed by dividing the second symmetric region by the diameter of the reference circle is defined as a third diffraction region and the other region is defined as a fourth diffraction region, one of regions formed by dividing a non-overlapping region of the reference circle and the first and second symmetric regions by the diameter of the reference circle is defined as a fifth diffraction region and the other region is defined as a sixth diffraction region, and the second diffraction unit extracts components of the second reflected light beam by the first, second, third, fourth, fifth, and sixth diffraction regions,
the detection unit independently detects the components of the second reflected light beam extracted by the first, second, third, fourth, fifth, and sixth diffraction regions,
the control unit controls tracking on the basis of a tracking error signal generated from a difference between a sum signal of the components of the second reflected light beam obtained from the first and fourth diffraction regions, and a sum signal of the components of the second reflected light beam obtained from the second and third diffraction regions,
the detection unit detects the second reflected light beam extracted by the fifth diffraction region by first and second detection regions, and detects the second reflected light beam extracted by the sixth diffraction region by third and fourth detection regions, and
the control unit controls focusing on the basis of a focus error signal generated from a difference between a sum signal of the components of the second reflected light beam detected by the second and third detection regions and a sum signal of the components of the second reflected light beam detected by the first and fourth detection regions.

14. An optical disk drive comprising:
an emission unit configured to emit a light beam;
a first diffraction unit configured to diffract the light beam emitted by the emission unit;
a polarization unit configured to pass one main beam and two sub beams formed by diffraction of the first diffraction unit, and to polarize a plurality of reflected light beams obtained from an optical disk in correspondence with these plurality of beams;
a focusing unit configured to focus the plurality of beams transmitted through the polarization unit on the optical disk;
a second diffraction unit configured to diffract a plurality of reflected light beams obtained from the. optical disk in correspondence with the plurality of beams focused on the optical disk by the focusing unit;
a detection unit configured to detect components of the plurality of reflected light beams diffracted by the second diffraction unit; and
a control unit configured to control tracking and focusing on the basis of the components of the reflected light beams detected by the detection unit,
wherein the second diffraction unit extracts components of a main reflected light beam obtained from the optical disk in correspondence with the main beam, and components of two sub reflected light beams obtained from the optical disk in correspondence with the two sub beams, and
the detection unit detects the components of the respective reflected light beams extracted by the second diffraction unit.

15. An optical disk drive according to claim 14, wherein the second diffraction unit has a circular form, which is defined as a reference circle, one of divided regions, which are formed by equally dividing the reference circle by a diameter thereof, is defined as a first divided region and the other divided region is defined as a second divided region, first and second circles, which are two circles symmetric about a center of the reference circle and have centers located on an extended line of a diameter of the reference circle, are defined, an overlapping region between the second divided region and the first circle is defined as a first diffraction region, an overlapping region between the second divided region and the second circle is defined as a second diffraction region, the first divided region is defined as a third diffraction region, a non-overlapping region of the first and second circles in the second divided region is defined as a fourth diffraction region, and the second diffraction unit extracts components of the main reflected light beam and components of the two sub reflected light beams by the first, second, third, and fourth diffraction regions,
the detection unit detects the components of the main reflected light beam, and the components of one of the two sub reflected light beams from components of the reflected light beams extracted by the first, second, third, and fourth diffraction regions,
the control unit controls tracking on the basis of a tracking error signal generated from a difference between a difference signal of components of the main reflected light beam obtained from the first and second diffraction regions, and a predetermined multiple of a difference signal of components of the sub reflected light beam obtained from the first and second diffraction regions,
the detection unit detects components of the reflected light beam extracted by the third diffraction region by first and second detection regions, and detects the reflected light beam extracted by the fourth diffraction region by third and fourth detection regions, and
the control unit controls focusing on the basis of a focus error signal generated from a difference between a sum signal of reflected light beam components detected by the second and third detection regions and a sum signal of reflected light beam components detected by the first and fourth detection regions.

16. An optical disk drive according to claim 14, wherein the second diffraction unit has a circular form, which is defined as a reference circle, one of divided regions, which are formed by equally dividing the reference circle by a diameter thereof, is defined as a first divided region and the other divided region is defined as a second divided region, first and second circles, which are two circles symmetric about a center of the reference circle and have centers located on an extended line of a diameter of the reference circle, are defined, an overlapping region between the second divided region and the first circle is defined as a first diffraction region, an overlapping region between the second divided region and the second circle is defined as a second diffraction region, the first divided region is defined as a third diffraction region, a non-overlapping region of the first and second circles in the second divided region is defined as a fourth diffraction region, and the second diffraction unit extracts components of the main reflected light beam and components of the two sub reflected light beams by the first, second, third, and fourth diffraction regions,
the detection unit detects the components of the main reflected light beam, and the components of one of the two sub reflected light beams from components of the reflected light beams extracted by the first, second, third, and fourth diffraction regions,
the control unit controls tracking on the basis of a tracking error signal generated from a difference between the components of the main reflected light beam obtained from the first diffraction region, and the components of the main reflected light beam obtained from the second diffraction region,
the detection unit detects components of the reflected light beam extracted by the third diffraction region by first and second detection regions, and detects the reflected light beam extracted by the fourth diffraction region by third and fourth detection regions, and
the control unit controls focusing on the basis of a focus error signal generated from a difference between a sum signal of reflected light beam components detected by the second and third detection regions and a sum signal of reflected light beam components detected by the first and fourth detection regions.

17. An optical disk drive according to claim 14, wherein the second diffraction unit has a circular form, which is defined as a reference circle, one of divided regions, which are formed by equally dividing the reference circle by a diameter thereof, is defined as a first divided region and the other divided region is defined as a second divided region, first and second circles, which are two circles symmetric about a center of the reference circle and have centers located on an extended line of a diameter of the reference circle, are defined, an overlapping region between the second divided region and the first circle is defined as a first diffraction region, an overlapping region between the second divided region and the second circle is defined as a second diffraction region, the first divided region is defined as a third diffraction region, a non-overlapping region of the first and second circles in the second divided region is defined as a fourth diffraction region, and the second diffraction unit extracts components of the main reflected light beam and components of the two sub reflected light beams by the first, second, third, and fourth diffraction regions,
the detection unit detects the components of the main reflected light beam, and the components of the two sub reflected light beams from components of the reflected light beams extracted by the first, second, third, and fourth diffraction regions,
the control unit multiplies by a predetermined value a difference signal between a sum signal of components of the first and second sub reflected light beams obtained from the first diffraction region, and a sum signal of components of the first and second sub reflected light beams obtained from the second diffraction region, and controls tracking on the basis of a tracking error signal generated from a difference between a difference signal of components of the main reflected light beam obtained from the first and second diffraction regions, and the multiplied difference signal,
the detection unit detects components of the reflected light beam extracted by the third diffraction region by first and second detection regions, and detects the reflected light beam extracted by the fourth diffraction region by third and fourth detection regions, and
the control unit controls focusing on the basis of a focus error signal generated from a difference between a sum signal of reflected light beam components detected by the second and third detection regions and a sum signal of reflected light beam components detected by the first and fourth detection regions.

18. An optical disk drive according to claim 14, wherein the second diffraction unit has a circular form, which is defined as a reference circle, one of divided regions, which are formed by equally dividing the reference circle by a diameter thereof, is defined as a first divided region and the other divided region is defined as a second divided region, first and second circles, which are two circles symmetric about a center of the reference circle and have centers located on an extended line of a diameter of the reference circle, are defined, an overlapping region between the second divided region and the first circle is defined as a first diffraction region, an overlapping region between the second divided region and the second circle is defined as a second diffraction region, the first divided region is defined as a third diffraction region, a non-overlapping region of the first and second circles in the second divided region is defined as a fourth diffraction region, and the second diffraction unit extracts components of the main reflected light beam and components of the two sub reflected light beams by the first, second, third, and fourth diffraction regions,
the detection unit detects the components of the main reflected light beam, and the components of the two sub reflected light beams from components of the reflected light beams extracted by the first, second, third, and fourth diffraction regions,
the control unit controls tracking on the basis of a tracking error signal generated from a difference between components of the main reflected light beam obtained from the first diffraction region, and components of the main reflected light beam obtained from the second diffraction region,
the detection unit detects components of the reflected light beam extracted by the third diffraction region by first and second detection regions, and detects the reflected light beam extracted by the fourth diffraction region by third and fourth detection regions, and
the control unit controls focusing on the basis of a focus error signal generated from a difference between a sum signal of reflected light beam components detected by the second and third detection regions and a sum signal of reflected light beam components detected by the first and fourth detection regions.

19. An optical system adjustment method for adjusting an optical system of an optical head, which comprises a first diffraction element for passing a second reflected light beam obtained from an optical disk in correspondence with a second light beam of first and second light beams having different wavelengths, and diffracting a first reflected light beam obtained from the optical disk in correspondence with the first light beam, a second diffraction element for passing a first reflected light obtained from the optical disk in correspondence with the first light beam and diffracting a second reflected light beam obtained from the optical disk in correspondence with the second light beam, and a photodetection element for detecting first diffracted light diffracted by the first diffraction element and second diffracted light diffracted by the second diffraction element, comprising:
adjusting a position of a light-receiving surface of the photodetection element with reference to the first diffracted light; and
adjusting a direction of the second diffracted light by rotating the second diffraction element so that the second diffracted light which is polarized in accordance with rotation of the second diffraction element is received by the light-receiving surface, the position of which is adjusted.
